(19) United States
(12) Patent Application Publication
(10) Pub. No.: US 2023/0065214 A1
(43) Pub. Date: Mar. 2, 2023

(54) METHOD FOR PROCESSING DATA IN THE ETL PROCESS, AND APPARATUS IMPLEMENTING THE SAME METHOD

(71) Applicant: SAMSUNG SDS CO., LTD., Seoul (KR)

(72) Inventors: Su Ho PARK, Seoul (KR); Eun Mi KIM, Seoul (KR)

(21) Appl. No.: 17/892,295

(22) Filed: Aug. 22, 2022

(30) Foreign Application Priority Data
Sep. 2, 2021 (KR) 10-2021-0116890

(51) Int. Cl. G06F 16/25

(52) U.S. Cl. CPC G06F 16/254

(57) ABSTRACT

A method for processing data in the ETL process according to an embodiment of the present disclosure includes retrieving data having a preset size from a database, storing the retrieved data having the preset size as raw data, performing a type casting operation of converting a type of the data to store the raw data in a target storage, loading the raw data converted via the type casting operation into a memory and when a size of the raw data loaded into the memory reaches a reference value, batch-processing the raw data loaded into the memory and storing the raw data in the target storage.

### CROSS-REFERENCE TO RELATED APPLICATION

This application claims the benefit under 35 USC § 119 of Korean Patent Application No. 10-2021-0116890 filed on Sep. 2, 2021 in the Korean Intellectual Property Office, the entire disclosure of which is incorporated herein by reference for all purposes.

### BACKGROUND

### 1. Technical Field

The present disclosure relates to a method for processing data in the extract, transform, and load (ETL) process, and an apparatus implementing the same method. More particularly, the present disclosure relates to a method for processing data in the ETL process, and an apparatus implementing the same method to provide a method for processing data in the ETL process of collecting and stacking data.

### 2. Description of the Related Art

With the advancement of analysis techniques, since the range of conventional used data is expanding, the role of the extract, transform, and load (ETL) area, which needs to collect and load more data, has been becoming more and more important.

The ETL is the process of extracting and converting data from a variety of data sources and loading the data into target systems such as Operation Data Store (ODS), Data Warehouse (DW) and Data Mart (DM), which is essential for analyzing and processing data in a big data environment.

In processing a large amount of data, collection and loading technologies have many numerous efficient tools with application advancement, but a Data Connection method that creates contact points for collection and loading is used in a traditional approach.

Such a conventional data connection method must be a stable technology; however, recently, computer performance increases while the memory costs are gettering cheaper, which requires a connection method capable of more efficiently processing data at a high speed.

Specifically, in the conventional data connection method in the ETL process, not only a value of source data but also another type of data, whether explicit or implied, needs to be certainly recognized and stored together with its source data. This process is referred to as casting in the technology of the establishing connection, and the conventional casting method allows the data to be processed in a single case unit, resulting in high casting costs and much resource consumption at the time of processing the large amount of data.

In addition, the conventional connection method processes data inflowing or outflowing via connection establishment in transaction units, which is a highly inefficient structure for a task that needs to process the large amount of data. In particular, when processing data in transaction units, since a between-class function that defines a processing flow of data on a program is called every time to increase the costs of function calls, it may cause an increase in the system resource costs by increasing data input/output (I/O).

Therefore, in the data connection technology of the ETL process, there is a need for a technology capable of processing data more efficiently and quickly than the conventional transaction unit data processing method. Furthermore, the technology is required to reduce the costs and resources consumed for casting and function calls compared to the conventional method.

### SUMMARY

Technical aspects to be achieved through an embodiment by the present disclosure provide a method for processing data in the ETL process, and an apparatus implementing the same method that can improve processing speed by collectively processing type casting performed during a data connection step in the ETL process in batch form instead of processing the type casting in transaction units.

Other technical aspects to be achieved through an embodiment by the present disclosure also provide a method for processing data in the ETL process, and an apparatus implementing the same method that can process data more efficiently and quickly than the conventional transaction unit data processing method during the data connection step in the ETL process.

Another technical aspects to be achieved through an embodiment by the present disclosure also provide a method for processing data in the ETL process, and an apparatus implementing the same method that can reduce the costs and resources consumed for casting and function calls at the time of processing data compared to the conventional transaction unit data processing method during the data connection step in the ETL process.

The technical aspects of the present disclosure are not restricted to those set forth herein, and other unmentioned technical aspects will be clearly understood by one of ordinary skill in the art to which the present disclosure pertains by referencing the detailed description of the present disclosure given below.

According to the present disclosure, a method for processing data in the ETL process executed by a computing device may include, retrieving data having a preset size from a database, storing the retrieved data having the preset size as raw data, performing a type casting operation of converting a type of the data to store the raw data in a target storage, loading the raw data converted via the type casting operation into a memory and when a size of the raw data loaded into the memory reaches a reference value, batch-processing the raw data loaded into the memory and storing the raw data in the target storage.

In an embodiment, the retrieving of data having a preset size from a database may include retrieving as much data as a preset fetch size from the database using a JAVA-based driver.

In an embodiment, the storing of the retrieved data having the preset size as raw data may include, acquiring type information of the raw data and storing the acquired type information of the raw data.

In an embodiment, the performing of a type casting operation of converting a type of the data to store the raw data in a target storage includes performing the type casting operation for the raw data using the stored type information of the raw data.

In an embodiment, the performing of a type casting operation for the raw data using the stored type information of the raw data may include calculating processing costs per type of the raw data consumed in the type casting operation.

In an embodiment, the performing of a type casting operation of converting a type of the data to store the raw data in a target storage may include converting the raw data having a binary form to match an object type of a target storage.

In an embodiment, the loading of the raw data converted via the type casting operation into a memory may include batch-processing a between-class function call operation performed at the time of converting the raw data via the type casting operation.

In an embodiment, the performing of a type casting operation of converting a type of the data to store the raw data in a target storage may include, dividing the raw data into a plurality of data groups using a certain data distinguisher and performing the type casting operation in parallel for data included in each of the divided data groups.

In an embodiment, the database and the target storage are arranged in different devices and data of the database and the target storage are processed based on different kinds of software.

According to another aspect of the present disclosure, an apparatus for processing data, may include, one or processors, a communication interface configured to communicate with an external device, a memory configured to load a computer program executed by the processor and a storage configured to store the computer program, wherein the computer program includes instructions for performing operations of retrieving data having a preset size from a database, storing the retrieved data having a preset size as raw data, performing a type casting operation of converting a type of the data to store the raw data in a target storage, loading the raw data converted via the type casting operation into a memory and when a size of the raw data loaded into the memory reaches a reference value, batch-processing the raw data loaded into the memory and storing the raw data in the target storage.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a conceptual diagram for explaining an embodiment of the present disclosure;

FIG. 2 is a block diagram illustrating a configuration of a data processing device according to an embodiment of the present disclosure;

FIG. 3 is a block diagram illustrating a configuration of a data processing device according to another embodiment of the present disclosure;

FIGS. 4 and 5 are flowcharts for explaining a method for processing data in the ETL process according to an embodiment of the present disclosure;

FIG. 6 is an exemplary view illustrating a process of a type casting operation for raw data according to an embodiment of the present disclosure;

FIG. 7 is an exemplary view illustrating a process of batch-processing raw data converted via the type casting operation according to an embodiment of the present disclosure; and

FIG. 8 is an exemplary diagram illustrating a hardware configuration of a computing device that can implement the methods according to an embodiment of the present disclosure.

### DETAILED DESCRIPTION

Hereinafter, exemplary embodiments of the present disclosure will be described with reference to the attached drawings. Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings

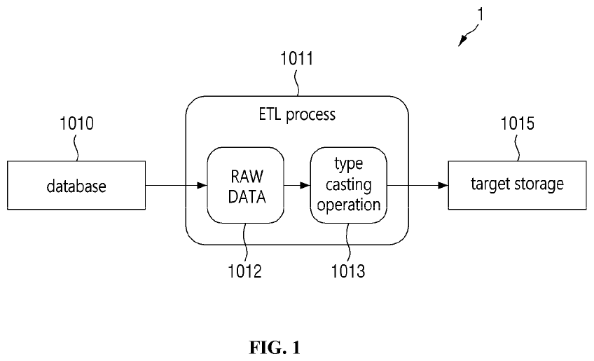

FIG. 1 is a conceptual diagram for explaining an embodiment of the present disclosure. Referring to FIG. 1, a data processing device 1 according to an embodiment of the present disclosure performs an ETL process 1011 configured to collect and loading data according to a user's request, and provides an interface configured to display a result of the performance.

The data processing device 1 performs the ETL process 1011 of collecting data from a database 1010 and stacking the collected data in a target storage 1015.

First, the data processing device 1 retrieves data having a preset size from the database 1010 and stores the data as raw data 1012. Herein, the database 1010 may be implemented, for example, with a relational database (RDB), but the present disclosure is not limited to a certain type of database.

The data processing device 1 performs a type casting operation 1013 of converting a type of data to store the raw data 1012 in the target storage 1015. In this case, the type of data may be converted to match an object type of the target storage 1015 by using type information of the raw data acquired at the time of retrieval from the database 1010.

When the raw data whose type is converted via the type casting operation 1013 is stored in the target storage 1015, the data processing device 1 may use a batch-processing method of loading the data into a memory in batch form rather than the transaction unit data processing method.

As described above, in accordance with the data processing device 1 according to an embodiment of the present invention, the processing speed may be improved by collectively processing the type casting performed during the data connection step in the ETL process in a batch form rather than the transaction unit data processing method.

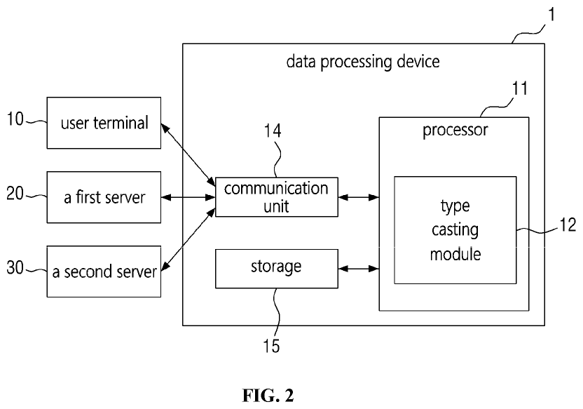

FIG. 2 is a block diagram illustrating a configuration of a data processing device according to an embodiment of the present disclosure. The data processing device 1 according to an embodiment of the present disclosure includes a communication unit 14, a storage 15 and a processor 11, and may be connected to a user terminal 10, a first server 20 and a second server 30 via the communication unit 14.

Herein, the first server 20 may be a device in which the database 1010 described in FIG. 1 is provided, and the second server 20 may be a device in which the target storage 1015 described in FIG. 1 is provided.

In an embodiment, data stored in the database 1010 of the first server 20 and the target storage 1015 of the second server 20 may be processed based on different kinds of software. For example, the database 1010 may be implemented with a relational database (RDB) such as PostgreSql, MariaDB, Oracle, etc. The target storage 1015 may be implemented with an import engine such as Hadoop or Ingest Accelerator.

The data processing device 1 may be a device that provides an interface capable of performing a series of operations for performing the ETL process, and may be implemented with the computing device such as a server or a PC.

The communication unit 14 communicates with the user terminal 10, the first server 20, and the second server 30 using a wired or wireless communication manner. The communication unit 14 may communicate with the user terminal 10, the first server 20, and the second server 30 via a wired communication manner such as Ethernet and the like, or may communicate therewith via a wireless communication manner such as Wi-Fi or Bluetooth. The manner of communication by the communication unit 14 is not limited thereto, and the present disclosure may communicate using other communication manners.

The storage 15 may store the data having a preset size retrieved from the database of the first server 20 and the type information of data acquired at the time of retrieving data. In addition, the storage 15 may store information required in each step of the ETL process, such as information on a batch size that is set at retrieval of the database.

The processor 11 may include a type casting module 12 and further include additional modules associated with the retrieval of data and partitioning of data.

The processor 11 receives, from the user terminal 10, requests of data extraction and loading from the first server 20 to the second server 30 and performs the ETL process according to a request from the user terminal 10.

The processor 11 retrieves the data having the preset size from the database of the first server 20, and stores the retrieved data having the preset size in the storage 15 as raw data.

The processor 11 may query the database 1010 of the first server 20 using a programming language-based driver to retrieve as much data as a preset fetch size and may store the retrieved data as raw data in the storage 15. In this case, a variety of programming language-based drivers, such as JAVA and Python, may be used as the programming language-based driver.

The type casting module 12 of the processor 11 may perform the type casting operation of converting the type of the raw data which is stored in the storage 15 in order to store them in the target storage 1015 of the second server 30.

The type casting module 12 may load type-converted raw data into the memory via the type casting operation, and, when the size of the data loaded in the memory reaches a reference value, the type casting module 12 may batch-process the loaded raw data and store them in the target storage 1015 of the second server 30.

In an embodiment, the type casting module 12 may perform an additional type conversion operation for processing the raw data in a specific programming language when the raw data needs to be modified or refined before performing the type casting operation of converting the type of data. For example, when it is required to modify and refine binary-shaped raw data, a type conversion operation may be first performed for converting the raw data into a type of JAVA language used in the ETL process, followed by the type casting operation of converting the type of data for storing the data in the target storage.

When the type casting module 12 desires to simply perform a data collection function without modifying or refining raw data, it may omit the process of converting a type to match the specific programming language and may perform only the type casting operation of performing conversion into the type of data suitable for the target storage. Accordingly, when the data processing device 1 performs only collection function without changing the data, some unnecessary processes may be minimized until extracting and loading the data, thereby improving the performance of the ETL process.

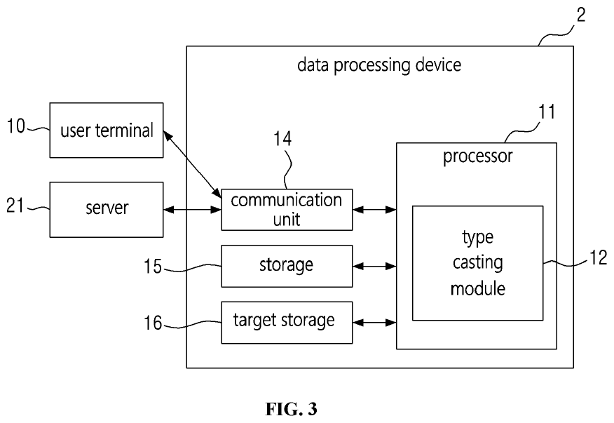

FIG. 3 is a block diagrams illustrating a configuration of a data processing device according to another embodiment of the present disclosure. The data processing device 2 according to another embodiment of the present disclosure includes the communication unit 14, the storage 15, a target storage 16 and the processor 11, and may be connected to the user terminal 10 and the server 21 via the communication unit 14. The data processing device 2 may be implemented with a computing device such as a server or a PC. The server 21 may be a device in which the database 1010 described in FIG. 1 is provided.

Since the communication unit 14 and the storage 15 of the data processing device 2 perform the same operation as the configuration of the data processing device 1 described in FIG. 2, a detailed description thereof will be omitted.

The data processing device 2 extracts the data from the database of the server 21 and thus makes the data loaded in the target storage 16, which is a component in the device, not in an external server.

The processor 11 may include the type casting module 12, and further include one or more additional modules associated with retrieval of data and partitioning of data.

In the illustrated view, when the processor 11 receives, from the user terminal 10, requests of the data extraction and loading from the server 21 to the target storage 16, it performs the ETL process accordingly.

The processor 11 retrieves the data having the preset size from the database of the server 21 and stores the retrieved data having the preset size in the storage 15 as raw data.

The processor 11 may query the database of the server 20, using a programming language-based driver to retrieve as much data as a preset fetch size, and it may store the retrieved data as raw data in the storage 15.

The type casting module 12 of the processor 11 may perform the type casting operation of converting the type of data to store the raw data stored in the storage 15 in the target storage 16.

The type casting module 12 may load type-converted raw data into the memory via the type casting operation, and, when the size of the data loaded in the memory reaches a reference value, the type casting module 12 may batch-process the loaded raw data and store them in the target storage of the second server 30.

According to the data processing device 2 according to the embodiment of the present disclosure, the processing speed may be improved by batch-processing the type casting performed during the data connection step in the ETL process in batch form, not in transaction units.

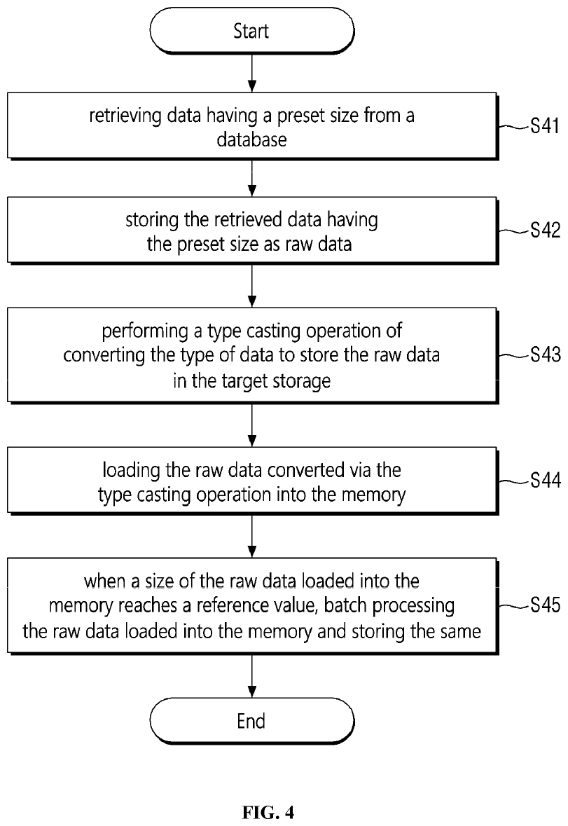

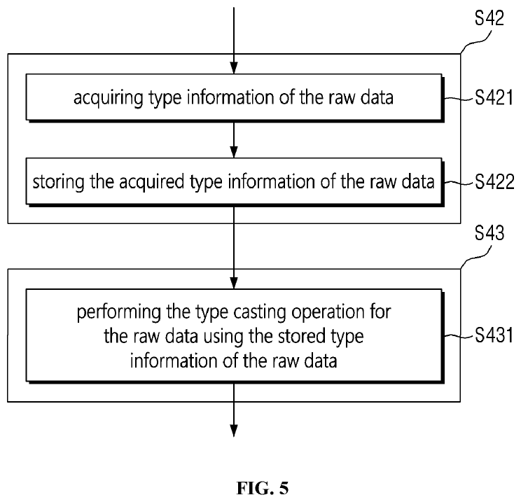

FIGS. 4 and 5 are flowcharts for explaining a method for processing data in the ETL process according to an embodiment of the present disclosure;

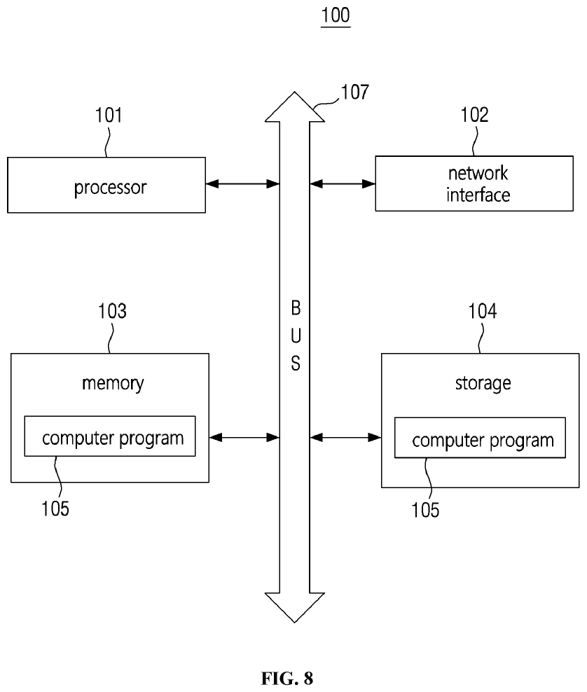

The data processing method of the ETL process according to an embodiment of the present invention may be executed by the computing device 100 of FIG. 8, for example, by the data processing device 1. The computing device 100 that executes a method according to the present embodiment may be a computing device having an application program execution environment installed therein. It is noted that the description of the subject of performing some operations included in the method according to the embodiments of the present disclosure may be omitted, and in this case, the subject is the computing device 100.

Referring to FIG. 4, in an operation S41, the data having a preset size is first retrieved from the database.

In an embodiment, the operation S41 may include an operation of retrieving as much data as a preset fetch size from the database using the JAVA-based driver. In this case, the query for retrieving as much data as the preset fetch size may be repeatedly performed.

Next, in an operation S42, the retrieved data having the preset size is stored as raw data.

Next, in an operation S43, the type casting operation of converting the type of data is performed to store the raw data in the target storage.

Referring to FIG. 5, the operation S42 may include an operation S421 of acquiring type information of the raw data and an operation S422 of storing the acquired type information of the raw data. The operation S43 may include an operation S431 of performing the type casting operation for the raw data using the type information of the raw data stored by the operation S422.

In the operation S431, the processing costs may be calculated per type of the raw data consumed in the type casting operation. In other words, at the time of calculating the costs consumed on the type casting operation, a method of calculating the cost per type of the raw data using the type information acquired from the raw data may be used instead of calculating the processing costs of the raw data accumulated in transaction units.

In an embodiment, in the operation S43, the type casting operation may include an operation of converting the raw data having a binary form to match the object type of the target storage.

In an embodiment, the operation S43 may include an operation of dividing the raw data into a plurality of data groups using a certain data distinguisher, and an operation of performing the type casting operation in parallel for data included in each of the divided data groups. In this case, for example, date may be used as a data distinguisher used at the time of dividing raw data into a plurality of data groups. That is, after dividing data into certain period units for parallel processing, the type casting operation may be performed for each of the divided data groups.

Next, in an operation S44, the raw data converted via the type casting operation is loaded into the memory. In this case, the raw data whose type is converted to match the object type of the target storage may be loaded into the memory in batch form.

In an embodiment, the operation S44 may include an operation of processing, in batch form, the between-class function call operation performed at the time of converting the raw data via the type casting operation. Accordingly, the conventional method of calling between-class functions every time in processing data during the data connection step of the ETL process may be improved a method of collectively processing data by placing them in memory in batch form, resulting in enhancing the data processing speed.

Finally, in an operation S45, when the size of the raw data loaded in the memory reaches the reference value, the raw data loaded in the memory is batch-processed and stored in the target storage. For example, the raw data is loaded into the memory up to the maximum allowable size of the memory, and when the loaded raw data exceeds the maximum allowable size of the memory, the raw data loaded in the memory may be batch-processed and stored in the target storage.

In an embodiment, the method may include the operations of: storing the retrieved data having the preset size retrieved from the database; performing a first type conversion operation of the stored data so that the stored data is processed in a specific programming language; and performing a second type conversion operation for the converted data so that the converted date via the first type-converted is stored in the target storage. In this case, when no change request for the stored data occurs, the first type conversion operation may be skipped.

According to embodiments of the present invention described above, only when a data collection function is simply performed without modifying or refining the raw data, the process of converting the type according to a specific programming language may be omitted, and only the type casting operation of performing conversion into the data type suitable for the target storage may be performed. Accordingly, only when the collection function is performed without any data modification, the change of the ETL process can be improved by minimizing unnecessary processes until collecting and loading the data.

As described above, according to the method of processing data in the ETL process according to embodiments of the present invention, the processing speed may be improved by collectively collecting the type casting performed during the data connection step in the ETL process in batch form, not in transaction units. In addition, during the data connection step in the ETL process, the costs and resources consumed for the casting and function calls at processing data can be more reduced than the transaction unit data processing method.

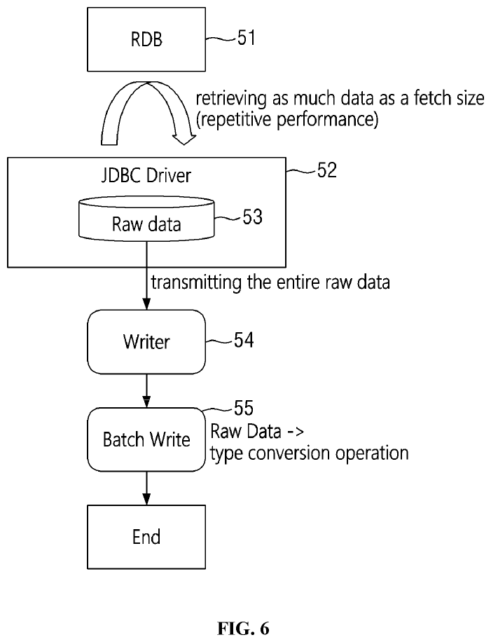

FIG. 6 is an exemplary view illustrating a process of operating type casting for raw data according to an embodiment of the present disclosure.

Referring to FIG. 6, the data processing device 1 performs a series of ETL processes for performing a type casting operation for raw data 53 acquired by retrieving data from an RDB 51 and storing the same in a target storage.

In the data processing device 1, a JAVA-based JDBC driver 52 may query the RDB 51 to retrieve as much data as the preset fetch size, and may repetitively perform such a process.

The JDBC driver 52 may store the data retrieved from the RDB 51 as the raw data 53, acquire the type information of the data recognized at retrieving the data, and store the data as type information of the raw data 53.

The JDBC driver 52 may transmit the stored raw data 53 to a writer 54, and transmit the entire raw data as much as the stored fetch size, not in transaction units.

The writer 54 may perform the type casting operation of converting the entire raw data transmitted from the JDBC driver 52 to match the object type of the target storage.

The writer 54 may load the raw data converted via the type casting operation into the memory in batch form, and for example, when the loaded raw data reaches the maximum allowable size of the memory, the writer 54 may batch-process the raw data loaded in the memory 55 and store the data in the target storage. In this case, the between-class function call operation performed at the time of converting the raw data via the type casting operation may be processed in batch form.

For example, the type casting operation for about 5,000 pieces of retrieved raw data among about 1 billion pieces of data stored in the RDB 51 may be loaded into the memory and processed in batch form.

As described above, according to an embodiment of the present disclosure, in performing the ETL process of storing the raw data have the preset size retrieved from RDB 51 in the target storage, when no modification or refinement of the raw data is required, that is, when requiring simply a collection function of loading the raw data in the target storage, only the type casting operation may be performed that converts the type to match the object type of the target storage without any additional type conversion operation for processing the raw data in the specific programming language. Accordingly, the processing speed of the ETL process may be improved by minimizing an unnecessary process until extracting and loading the data.

In addition, the data processing in batch form rather than in transaction units during the data connection step of the ETL process has the advantage of reducing the costs and resources consumed for casting and function calls.

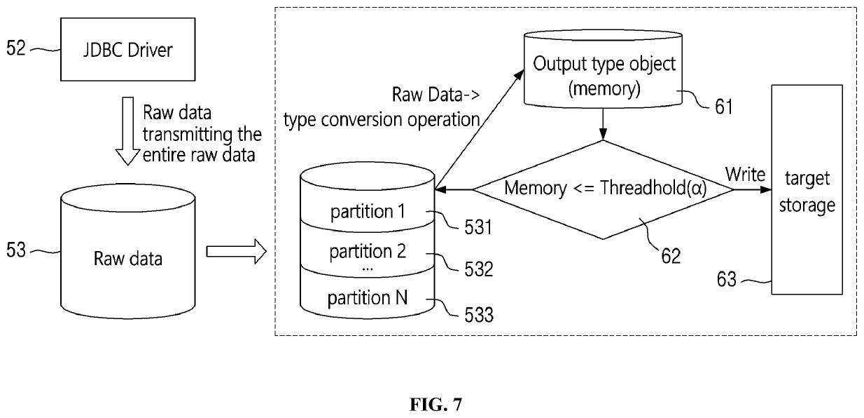

FIG. 7 is an exemplary view illustrating a process of batch-processing raw data converted via the type casting operation according to an embodiment of the present disclosure.

As described above with reference to FIG. 6, the JDBC driver 52 of the data processing device 1 may transmit the entire stored raw data 53 to the writer 54 to perform the type casting operation.

Referring to FIG. 7, the writer 54 may perform partitioning in which the entire transmitted raw data 53 are divided into a plurality of groups.

In an embodiment, the writer 54 may divide the entire raw data 53 into three groups, a partition 1 531, a partition 2 532 and a partition 3 533, and may perform type casting operations in parallel for each of the partition groups. In this case, the entire raw data 53 may be divided into respective partition groups using a certain data distinguisher such as a date and the like. In this case, the data sizes of each of the partition groups may be set equal to each other or set different from each other according to a user's designation.

In an embodiment, when the type casting operation is performed for the raw data included in each of the partition groups, the raw data converted via the type casting operation may be loaded into the memory 61 in batch form.

In this case, it is determined whether the size of the raw data loaded in the memory 61 is less than or equal to the reference value (62), and, when the size of the raw data is less than or equal to the reference value, the raw data converted via the type casting operation is continuously loaded in the memory (61). However, when the size of the raw data loaded in the memory 61 exceeds the reference value, the raw data may no longer be loaded in the memory 61, and the entire raw data that were previous loaded may be batch-processed and stored in the target storage 63.

According to an embodiment of the present disclosure, in the case of performing the ETL process of storing the raw data having the preset size retrieved from the RDB 51 in the target storage, the raw data may be divided into a preset number of groups, and the type casting operations for each of the divided groups may be performed in parallel, thereby shortening the processing time of the ETL process consumed until extracting and loading the data.

In addition, when performing the type casting actions for each of the divided groups, the costs and resources consumed on the casting and the function calls can be reduced by using the batch-processing method for loading the data into memory in batch form rather than transaction units.

FIG. 8 is an example hardware diagram illustrating a computing device 100. As shown in FIG. 8, the computing device 100 may include one or more processors 101, a bus 107, a communication interface 102, a memory 103, which loads a computer program 105 executed by the processors 101, and a storage 104 for storing the computer program 105. However, FIG. 8 illustrates only the components related to the embodiment of the present disclosure. Therefore, it will be appreciated by those skilled in the art that the present disclosure may further include other general purpose components in addition to the components shown in FIG. 8.

The processor 101 controls overall operations of each component of the computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing device 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of the computing device 100. The bus 107 may be implemented as various types of bus such as an address bus, a data bus and a control bus.

The communication interface 102 supports wired and wireless internet communication of the computing device 100. The communication interface 102 may support various communication methods other than internet communication. To this end, the communication interface 102 may be configured to include a communication module well known in the art of the present disclosure.

The storage 104 can non-temporarily store one or more computer programs 105. The storage 104 may be configured to include a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 105 may include one or more instructions, on which the methods/operations according to various embodiments of the present disclosure are implemented. For example, the computer program 105 may include instructions for executing operations including retrieving data having a preset size from a database, storing the retrieved data having the preset size as raw data, performing a type casting operation of converting a type of the data to store the raw data in a target storage, loading the raw data converted via the type casting operation into a memory and when a size of the raw data loaded into the memory reaches a reference value, batch-processing the raw data loaded into the memory and storing the raw data in the target storage.

When the computer program 105 is loaded on the memory 103, the processor 101 may perform the methods/operations in accordance with various embodiments of the present disclosure by executing the one or more instructions.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the exemplary embodiments without substantially departing from the principles of the present disclosure. Therefore, the disclosed exemplary embodiments of the disclosure are used in a generic and descriptive sense only and not for purposes of limitation.

What is claimed is:

1. A method for processing data in an extract, transform, and load (ETL) process performed by a computing device, the method comprising:
retrieving data having a preset size from a database;
storing the retrieved data having the preset size as raw data;
performing a type casting operation of converting a type of the raw data to match an object type of a target storage;
loading the raw data converted via the type casting operation into a memory; and
when a size of the raw data loaded into the memory reaches a reference value, batch-processing the raw data loaded into the memory and storing the raw data in the target storage.

2. The method of claim 1, wherein the retrieving of the data comprises retrieving as much data as a preset fetch size from the database by using a JAVA-based driver.

3. The method of claim 1, wherein the storing of the retrieved data comprises:
acquiring type information of the raw data; and
storing the acquired type information of the raw data.

4. The method of claim 3, wherein the performing of the type casting operation comprises performing the type casting operation for the raw data by using the stored type information of the raw data.

5. The method of claim 4, wherein the performing of the type casting operation for the raw data by using the stored type information of the raw data comprises calculating processing costs per type of the raw data consumed in the type casting operation.

6. The method of claim 1, wherein the performing of the type casting operation comprises converting the raw data having a binary form to match the object type of the target storage.

7. The method of claim 1, wherein the loading of the raw data comprises batch-processing a between-class function call operation performed at the time of converting the raw data via the type casting operation.

8. The method of claim 1, wherein the performing of the type casting operation comprises:
dividing the raw data into a plurality of data groups by using a data distinguisher; and
performing the type casting operation in parallel for data included in each of the divided data groups.

9. The method of claim 1, wherein the database and the target storage are arranged in different devices, and
the data of the database and the target storage are processed based on different kinds of software.

10. An apparatus for processing data, comprising one or processors;
a communication interface configured to communicate with an external device;
a memory configured to load a computer program executed by the processor; and
a storage configured to store the computer program,
wherein the computer program comprises instructions for performing operations of:
retrieving data having a preset size from a database;
storing the retrieved data having a preset size as raw data;
performing a type casting operation of converting a type of the data to match an objective type of a target storage;
loading the raw data converted via the type casting operation into a memory; and
when a size of the raw data loaded into the memory reaches a reference value, batch-processing the raw data loaded into the memory and storing the raw data in the target storage.

11. The apparatus of claim 10, wherein the operation of performing the type casting operation comprises converting the raw data having the binary form to match the object type of the target storage.

12. The apparatus of claim 10, wherein the operation of loading the raw data comprises batch-processing a between-class function call operation performed at the time of converting the raw data via the casting operation.

13. The apparatus of claim 10, wherein the operation of retrieving data comprises retrieving as much data as a preset fetch size from the database using a JAVA-based driver.

14. The apparatus of claim 10, wherein the operation of storing the data comprises:
acquiring type information of the raw data; and
storing the acquired type information of the raw data.

15. The apparatus of claim 14, wherein the operation of performing the type casting operation comprises performing the type casting operation for the raw data by using the stored type information of the raw data.

16. The apparatus of claim 10, wherein the operation of performing the type casting operation for the raw data using the stored type information of the raw data comprises calculating processing costs per type of the raw data consumed in the type casting operation.

17. The apparatus of claim 10, wherein the operation of performing the type casting operation comprises:
dividing the raw data into a plurality of data groups by using a data distinguisher; and
performing the type casting operation in parallel for data included in each of the divided data groups.

18. The apparatus of claim 10, wherein the database and the target storage are arranged in different devices; and
the data of the database and the target storage are processed based on different kinds of software.
